(19) United States
(12) Patent Application Publication
(10) Pub. No.: US 2005/0244780 A1
(43) Pub. Date: Nov. 3, 2005

(54) Torque spring for double wire orthodontic treatment

(76) Inventors: Norbert Abels, Homburg (DE); Claus-H. Backes, Saarbrucken (DE)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/835,972

(22) Filed: Apr. 30, 2004

(51) Int. Cl. A61C 3/00

(52) U.S. Cl. 433/21

(57) ABSTRACT

A torque spring includes two curved arch wire portions that are configured to engage secondary arch wire slots of brackets attached to at least a person's canines and bicuspids on either side of a person's incisors. The torque spring also includes two or more bent regions between the curved arch wire portions that substantially frame the selected incisors so as to tip the incisors in a desired direction during an orthodontic treatment. The engagement between the bent regions and the framed incisors causes the incisors to tip in place, correcting any abnormal inclination of the incisors. The inventive torque spring may be used in combination with a primary arch wire to concurrently correct a plurality of different malocclusions.

### BACKGROUND OF THE INVENTION

1. The Field of the Invention

The present invention relates to orthodontics, more particularly to correction of lateral inclination of the incisors.

2. The Relevant Technology

Orthodontics is a specialized field of dentistry that involves the application of mechanical forces to urge poorly positioned, or crooked, teeth into correct alignment and orientation. Orthodontic procedures can be used for cosmetic enhancement of teeth, as well as medically necessary movement of teeth or the jaw to correct underbites or overbites. For example, orthodontic treatment can improve the patient's occlusion, or enhanced spatial matching of corresponding teeth.

Often, a person's incisors may exhibit a lateral inclination. A lateral inclination of the incisors may cause the incisors to tip either forward (labially) or backward (lingually). Generally, inclination of the incisors is aesthetically undesirable as it affects the appearance of the person's smile. In addition, inclination of the incisors typically occurs concurrently with various other malocclusions such as crowding, rotated teeth, an underbite, or an overbite.

Generally, existing methods and apparatus for correcting malocclusions require a sequential approach. Such a limitation requires a significant amount of treatment time as individual issues must be treated in sequence.

Therefore, it would be an improvement in the art to provide a device that can be used to correct inclination of a person's incisors while allowing concurrent treatment and correction of additional malocclusion conditions.

### BRIEF SUMMARY OF THE PREFFERED EMBODIMENTS

The torque spring of the present invention includes two curved arch wire portions that are configured to engage secondary arch wire slots of brackets attached to at least a person's canines and bicuspids on either side of a person's incisors. The torque spring also includes two or more bent regions between the curved arch wire portions that substantially frame the selected incisors so as to tip the incisors in a desired direction during an orthodontic treatment. The engagement between the bent regions and the incisors causes the incisors to tip in place, either labially or lingually, thereby correcting any abnormal inclination of the incisors.

The torque spring may be used to correct inclination of any of the incisors. It may be used with the first and/or second incisors of the upper or lower dental arch.

The torque spring may be made from any suitable arch wire material. Examples of suitable materials include stainless steel, titanium, and titanium alloys. Preferably, any metals used are substantially nickel free or have a low nickel content so as to avoid patient sensitivity which can sometimes be caused by exposure to nickel.

Because the torque spring is configured for engagement in brackets having at least two arch wire slots, the torque spring may be used concurrently with a primary arch wire configured to correct other malocclusions. The primary arch wire may be used to correct other malocclusions of the teeth, while the torque spring is concurrently used to correct inclination of the incisors.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view of an exemplary torque spring according to the invention;

FIG. 2A is a perspective view of an exemplary torque spring installed so as to correct inclination of the first upper incisors;

FIG. 2B illustrates termination of the end of the torque spring within an orthodontic bracket bonded to a person's first bicuspid;

FIG. 3A illustrates an upper dental arch with orthodontic brackets bonded to eight of the teeth of the upper dental arch;

FIG. 3B illustrates insertion of a torque spring into the secondary arch wire slots of the orthodontic brackets;

FIG. 3C illustrates the torque spring having been installed into the secondary arch wire slots of the orthodontic brackets;

FIG. 3D illustrates insertion of a primary arch wire into the primary arch wire slots of the orthodontic brackets;

FIG. 3E illustrates the front eight teeth of an upper dental arch with a torque spring and primary arch wire installed, and the ligating covers of the self-ligating orthodontic brackets having been closed.

### DETAILED DESCRIPTION OF THE PREFERRED EMBODIMENTS

I. Introduction

The torque spring of the present invention includes two curved arch wire portions that are configured to engage secondary arch wire slots of brackets attached to at least a person's canines and bicuspids on either side of a person's incisors. The torque spring also includes two or more bent regions between the curved arch wire portions that substantially frame selected incisors so as to tip the incisors in a desired direction during an orthodontic treatment. The engagement between the bent regions and the framed incisors causes the first incisors to tip in place either lingually or labially, thereby correcting any abnormal inclination of the incisors.

II. Exemplary Torque Spring

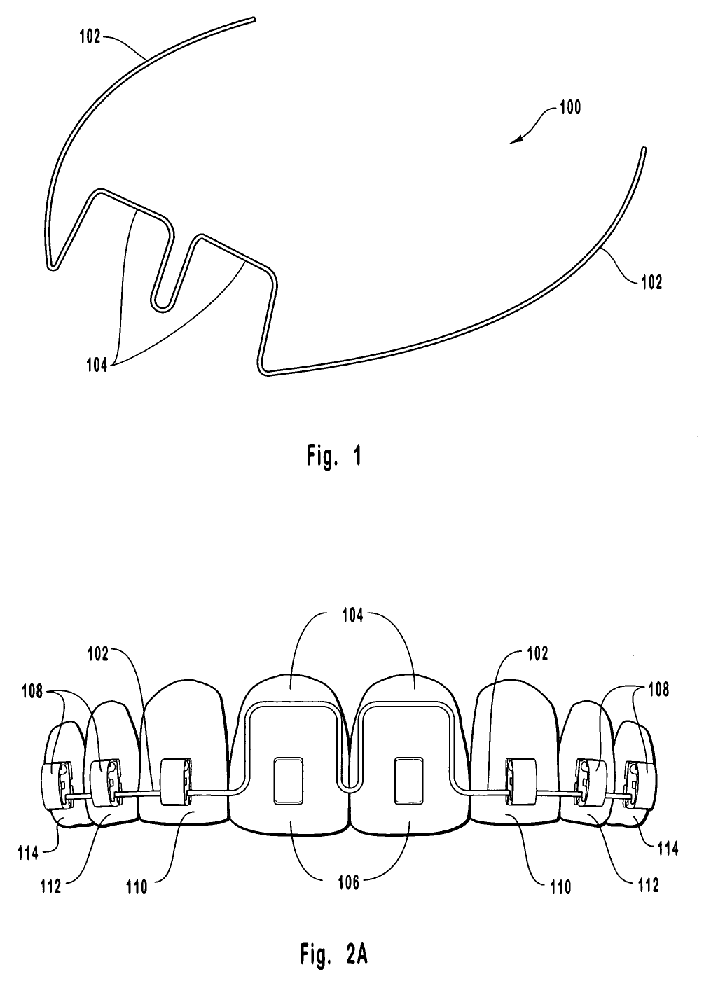

FIG. 1 illustrates an exemplary torque spring 100. The torque spring 100 includes curved arch wire portions 102 and two (more could be included) bent regions 104. The two curved arch wire portions 102 are configured to engage secondary arch wire slots of orthodontic brackets attached to the teeth adjacent to the incisors to be tipped. The bent regions 104 are situated between the curved arch wire portions 102 and are configured so as to substantially frame the incisors to be tipped. The illustrated embodiment substantially frames just the first incisors. Alternative embodiments may include different configurations that frame the second incisors or any combination of first and second incisors. Contact between the bent regions 104 and the incisors applies the necessary force to tip the inclined incisors as desired, either labially or lingually.

The torque spring 100 may be made from any suitable arch wire material. Examples of suitable materials include stainless steel, titanium, and titanium alloys. Preferably, any metals used are substantially nickel free or have a low nickel content so as to avoid patient sensitivity which can sometimes be caused by exposure to nickel.

FIGS. 2A-2B illustrate torque spring 100 having been installed so as to correct an inclination of the first incisors 106. The curved arch wire portions 102 are engaged within the secondary arch wire slots of brackets 108 bonded to the second incisors 110, canines (or cuspids) 112, and first bicuspids 114. The bent regions 104 substantially frame the first incisors 106 and apply a correcting force to the first incisors 106.

As better seen in FIG. 2B, and according to one embodiment, the torque spring 100 terminates at the bracket bonded to the person's first bicuspid 114. It is, of course, within the scope of the invention to terminate the torque spring at any appropriate tooth depending on which incisors are being treated and/or how long the curved arch wire portions 102 are. By way of example, a torque spring used to correct the first incisors and long enough to span ten teeth will terminate at the brackets attached to the second bicuspids. Similarly, a torque spring used to correct the first and second incisors in the right quadrant of a patient's teeth and long enough to span eight teeth will terminate at the brackets attached to the left canine (or cuspid) and the right second bicuspid.

III. Exemplary Method of Use

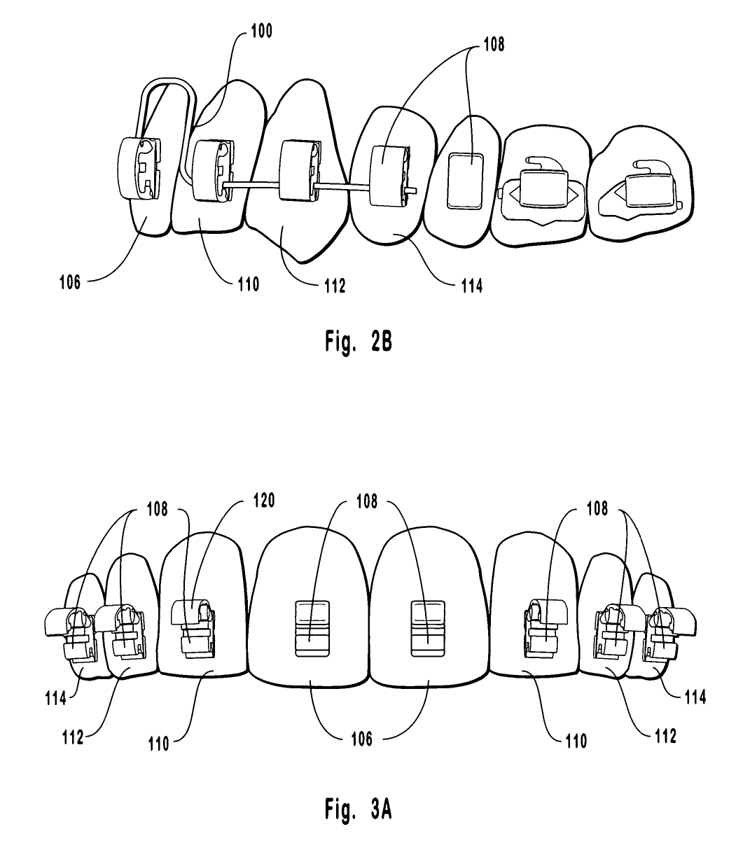

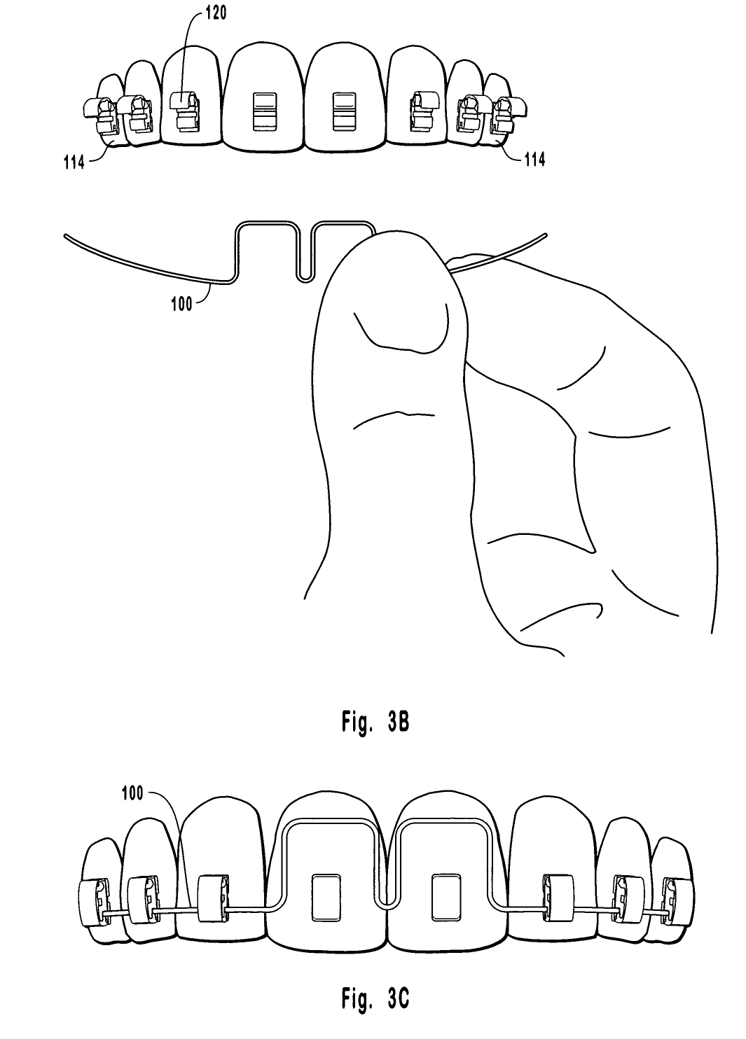

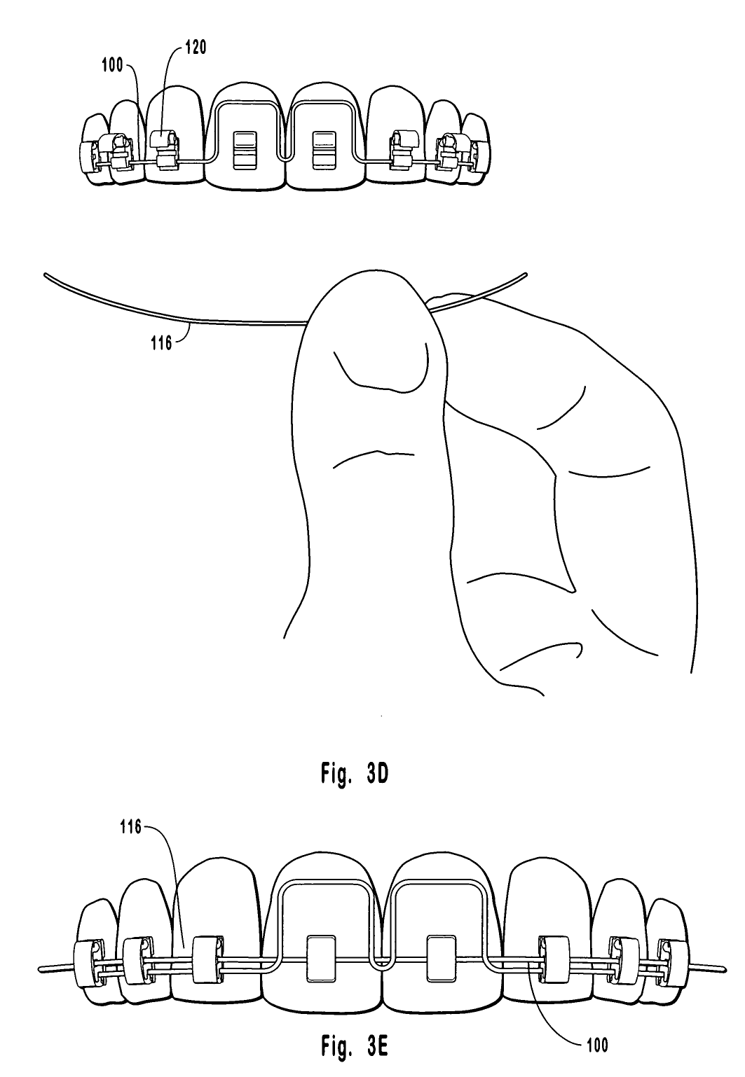

FIGS. 3A-3E illustrate an exemplary method of installing and using the torque spring 100. FIG. 3A shows an upper dental arch where self-ligating orthodontic brackets have been bonded to eight of the teeth of the upper dental arch. The ligation covers 120 of the brackets 108 are in the open, non-ligating position, ready to receive a torque spring and primary arch wire.

Thereafter, the ends of curved arch wire portions 102 of torque spring 100 are inserted into the secondary arch wire slots of the orthodontic brackets bonded to the first bicuspids 114, as illustrated in FIG. 3B. The curved arch wire portions 102 are also inserted into the secondary arch wire slots of the orthodontic brackets bonded to the person's second incisors 110 and canines (or cuspids) 112. The bent regions 104 between the curved arch wire portions 102 are then adjusted so as to apply the desired torquing force so as to tip the first incisors 106 in a desired manner during treatment. The ligation covers 120 of the self-ligating orthodontic brackets may then be closed so as to retain the torque spring 100 within the secondary arch wire slots of the brackets, as shown in FIG. 3C.

Alternatively, the torque spring 100 may be used concurrently with a primary arch wire for correcting the spacing and orientation of teeth. In this way, the primary arch wire may be placed in the primary arch wire slots of orthodontic brackets placed on the teeth of the person while the torque spring is used to concurrently tip any of the first or second incisors. FIG. 3D illustrates insertion of a primary arch wire 116 into the primary arch wire slots of the orthodontic brackets 108 bonded to eight of the teeth of the upper dental arch, with the ligation covers 120 being open to receive the primary arch wire 116 within the primary arch wire slots. The covers 120 of the brackets 108 on the first bicuspids (or any other desired tooth) may remain closed so as to hold the torque spring in place. FIG. 3E illustrates the dental arch after all ligation covers of the orthodontic brackets have been closed. It will be appreciated that the primary arch wire 116 may be received within brackets attached to any or all of a patient's second bicuspids and first and second molars.

Although illustrated in conjunction with treatment of the first incisors of the upper dental arch, the torque spring could alternatively be used for correction of any inclination of any of the incisors, in a similar manner. For example, the torque spring may be shifted to the left or to the right to correct first and second incisors on either the left or right quadrant of teeth. Alternatively, the torque spring may include bent regions that substantially frame three or four incisors in order to correct inclination of three or four incisors, respectively.

It will also be appreciated that the inventive torque springs may be used with other types of orthodontic brackets in addition to, or instead of, the self-ligating brackets illustrated in the drawings, including, but not limited to, other types of self-ligating brackets and/or non-self-ligating brackets that require ligatures to retain the torque spring and/or primary arch wire within the slots.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A torque spring comprising:
two curved arch wire portions that are configured to engage secondary arch wire slots of brackets attached to one or more of a patient's canines and bicuspids on either side of a patient's incisors; and
two or more bent regions between the curved arch wire portions that substantially frame two or more incisors so as to tip the substantially framed incisors in a desired direction during an orthodontic treatment.

2. A torque spring as recited in claim 1, wherein the torque spring includes two bent regions configured to substantially frame a patient's first incisors, wherein said curved arch wire portions further engage secondary arch wire slots of brackets attached to the patient's second incisors.

3. A torque spring as recited in claim 1, wherein the torque spring includes two bent regions configured to substantially frame both first incisors of a dental arch.

4. A torque spring as recited in claim 1, wherein the torque spring includes two bent regions configured to substantially frame both second incisors of a dental arch.

5. A torque spring as recited in claim 1, wherein the torque spring includes two or more bent regions configured to substantially frame any combination of first and second incisors.

6. A torque spring as recited in claim 1, wherein the torque spring includes two or more bent regions configured to substantially frame two or more upper incisors.

7. A torque spring as recited in claim 1, wherein the torque spring includes two or more bent regions configured to substantially frame two or more lower incisors.

8. A torque spring as recited in claim 1, wherein said torque spring is formed of stainless steel, titanium, or a titanium alloy.

9. A torque spring as recited in claim 1, wherein said torque spring is formed of a metal substantially free of nickel.

10. A method of installing a torque spring comprising:
providing a torque spring as recited in claim 1;
inserting one of said curved arch wire portions into a secondary arch wire slot of a first orthodontic bracket having primary and secondary arch wire slots and the other of said curved arch wire portions into a secondary arch wire slot of a second orthodontic bracket having primary and secondary arch wire slots;
substantially framing two or more incisors with said two or more bent regions of said torque spring;
adjusting said two or more bent regions so that they apply a force to the substantially framed incisors so as to tip the substantially framed incisors in a desired direction during orthodontic treatment.

11. A method-as recited in claim 10, wherein said first and second orthodontic brackets are bonded to a person's bicuspids.

12. A method as recited in claim 11, further comprising inserting the curved arch wire portions into the secondary arch wire slots of additional orthodontic brackets bonded to a person's canines.

13. A method as recited in claim 12, further comprising inserting the curved arch wire portions into the secondary arch wire slots of additional orthodontic brackets bonded to a person's second incisors.

14. A method as recited in claim 10, wherein the substantially framed two or more incisors comprise a first incisor and a second incisor.

15. A method as recited in claim 14, wherein the substantially framed first and second incisors are in one quadrant of a patient's teeth, and wherein one of the curved portions engages secondary arch wire slots of orthodontic brackets bonded to the patients other first incisor and second incisor of the opposite quadrant of the same upper or lower dental arch.

16. A method as recited in claim 10, wherein the two or more bent regions comprise three bent regions that substantially frame three incisors.

17. A method as recited in claim 10, wherein the two or more bent regions comprise four bent regions that substantially frame four incisors.

18. A method as recited in claim 10, wherein said orthodontic brackets are self-ligating.

19. A method as recited in claim 18, further comprising closing the cover of each self-ligating bracket so as to retain said torque spring within the secondary arch wire slot of each orthodontic bracket.

20. A method as recited in claim 10, further comprising installing a primary arch wire into the primary arch wire slots of the orthodontic brackets.

21. A kit comprising:
A torque spring as recited in claim 1;
A plurality of self-ligating brackets having a base and a ligation cover.

22. A kit as recited in claim 21, further comprising a primary arch wire for correcting other malocclusions.
